(19) United States
(12) Patent Application Publication
(10) Pub. No.: US 2009/0139548 A1
(43) Pub. Date: Jun. 4, 2009

(54) Apparatus and method of rinsing and drying semiconductor wafers

(75) Inventor: Hong-Seok Kim, Gyeonggi-do (KR)

Correspondence Address: MARGER JOHNSON & MCCOLLOM, P.C., 210 SW MORRISON STREET, SUITE 400, PORTLAND, OR, 97204, US

(73) Assignee: Samsung Electronics Co., Ltd., Suwon-si (KR)

(21) Appl. No.: 12/378,565

(22) Filed: Dec. 18, 2008

Related U.S. Application Data
(62) Division of application No. 11/101,799, filed on Apr. 7, 2005.

(30) Foreign Application Priority Data
Apr. 9, 2004 (KR) 2004-24511

(51) Int. Cl. B08B 3/00

(52) U.S. Cl. 134/26

(57) ABSTRACT

An apparatus for rinsing and drying semiconductor wafers includes a rinsing bath, a drying bath and a drying chamber. The rinsing bath and drying bath are connected by a tunnel unit which prevents semiconductor wafers from being exposed to air while being transferred from the rinsing bath to the drying bath. Thus watermarks are prevented from being formed on the semiconductor wafers. A method for rinsing and drying semiconductor wafers includes rinsing the wafers in a rinsing bath, transferring the wafers to a drying bath through a tunnel unit that prevents the semiconductor wafers from the being exposed to air, and after processing the wafers in the drying bath, transferring the wafers to a drying chamber.

This application is a Divisional of U.S. patent application Ser. No. 11/101,799, filed on Apr. 7, 2005, now pending, which claims priority under 35 U.S.C. § 119 from Korean Patent Application No. 2004-24511 filed on Apr. 9, 2004, in the Korean Intellectual Property Office, the entire contents of which are hereby incorporated by reference

### BACKGROUND OF THE INVENTION

1. Field of the Invention

The present invention relates to an apparatus for manufacturing a semiconductor device, and more particularly, to an apparatus and method of rinsing and drying a semiconductor wafer.

2. Description of the Related Art

Rinsing and drying processes are frequently performed during a semiconductor manufacturing process. For example, after particles or a natural oxide layer are removed through a cleaning process, the residual cleaning agent is removed through the rinsing and drying processes. In addition, the rinsing and drying processes are performed as a final process in an etching or ashing process for patterning a layer. To perform the rinsing process, DI water is used to rinse a semiconductor wafer processed with chemical agent such as cleaning liquid. In the drying process, the semiconductor wafer having undergone the rinsing process is dried.

It is important in the rinsing and drying processes that no watermark is formed on the silicon wafer. The watermark is a kind of a silicon oxide layer that is formed by the oxygen dissolved in the DI water and reacted with the silicon wafer. The watermark is formed when the wafer is exposed to the air in the course of transferring the wafer from a rinse bath to a drying bath. The longer the exposing time of the wafer to the air, the more the watermarks are formed.

To prevent the watermarks from being formed, the drying process should be performed without exposing the silicon wafer to the air after the rinsing process is performed. Korean laid-open Patent No. 2001-0096566 discloses an apparatus for cleaning a semiconductor wafer. In this patent, the cleaning agent treating, rinsing and drying processes (hereinafter referred as “cleaning process”) are performed without exposing the wafer to the air. That is, the treating, rinsing and drying processes are performed in a bath where the semiconductor wafer is loaded. The drying process is performed by a marangoni dryer installed above the bath.

However, the cleaning apparatus disclosed in the patent has to have all units for performing the treating, rinsing and drying processes, thereby being complicated in its structure. Furthermore, it is difficult to separate the rinsing process and the drying process from each other. The rinsing and drying processes cannot be performed independently separated from the treating process. Therefore, the cleaning apparatus cannot be used for an operation in which only the rinsing and drying process are required.

Furthermore, only after a cleaning process for the wafers loaded in one cassette is performed can a cleaning process for the wafers loaded in another cassette be performed, deteriorating the throughput of the cleaning process. Since the treating and rinsing processes are performed in a single common bath, the impurities and cleaning agent cannot be effectively treated.

### SUMMARY OF THE INVENTION

The present disclosure provides an apparatus and method of rinsing and drying semiconductor wafers that prevent watermarks from being formed on the semiconductor wafers. The apparatus and method prevent watermarks from being formed on the semiconductor wafers by preventing the semiconductor wafers from being exposed to air between the rinsing and drying processes.

The apparatus includes a rinsing bath, a drying bath and a drying chamber. The rinsing bath and drying bath are connected by a bath tunnel unit that prevents the semiconductor wafers from being exposed to air while being transferred from the rinsing bath to the drying bath.

The method includes rinsing the semiconductor wafers in a rinsing bath and then transferring the semiconductor wafers through a tunnel unit isolated that is isolated from air to a drying bath. After the semiconductor wafers are processed in the drying bath, they are transferred within the same unit to a drying chamber.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view of an apparatus of rinsing and drying a semiconductor wafer according to an embodiment of the present invention;

FIG. 2 is a schematic side view illustrating a structure of first and second guide supports and a wafer transferring method;

FIG. 3 is a schematic view of the closing/opening unit of FIG. 1, according to an embodiment of the present invention; and

FIG. 4 is a flowchart illustrating a method of an apparatus of rinsing and drying a semiconductor wafer according to an embodiment of the present invention.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity.

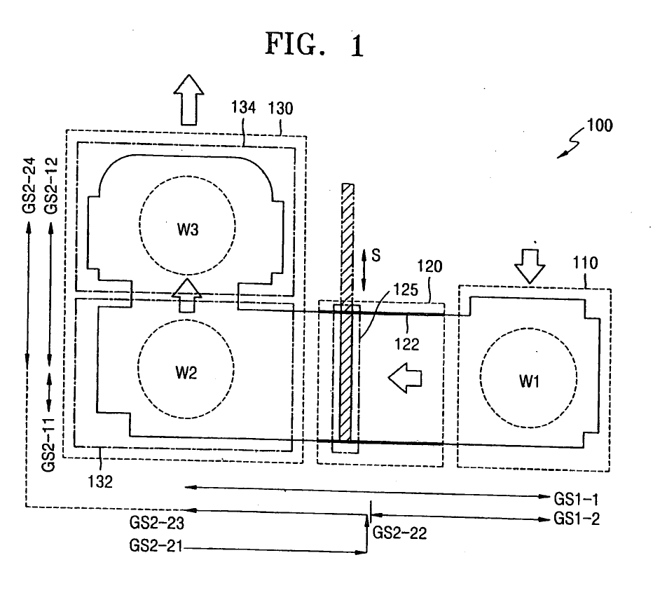

FIGS. 1-3 show an apparatus for rinsing and drying a semiconductor wafer according to an embodiment of the present invention.

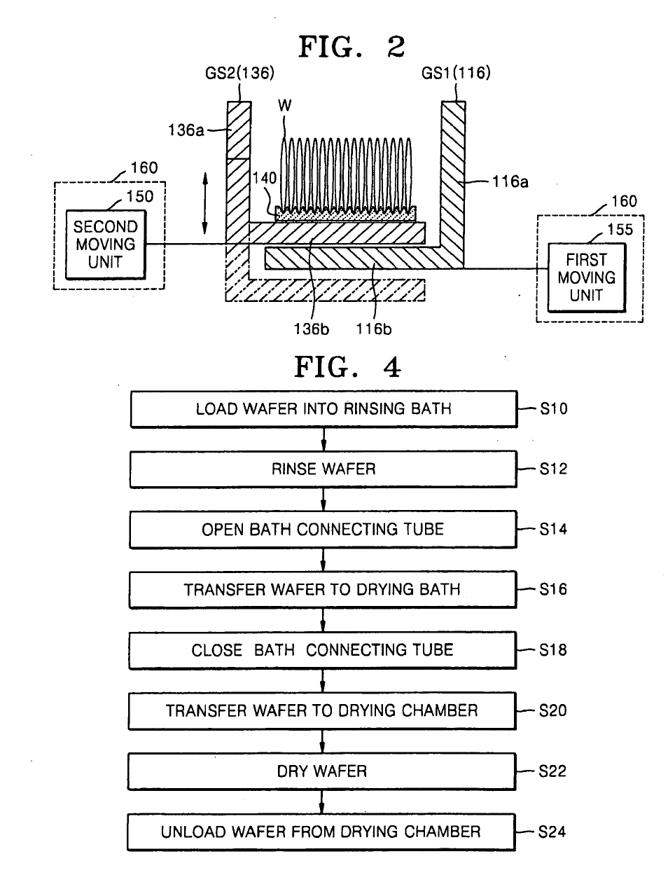

As shown in the drawings, a rinsing/cleaning apparatus 100 for a semiconductor wafer includes a rinsing unit 110, a drying unit 130, a bath tunnel unit 120, and a wafer transferring unit 160. The rinsing/cleaning apparatus 100 may further include a wafer guide 140 provided with a plurality of slits for carrying a plurality of wafers W (see FIG. 2). However, when the wafers are loaded in the rinsing unit 110 in a state where they are installed on the wafer guide 140, there is no need to provide the wafer guide 140 to the rinsing/cleaning apparatus 100.

The rinsing unit 110 includes a rinsing bath (not shown) in which a rinsing process for the semiconductor wafer W1 is performed and a first guide support GS1 supporting the wafer guide 140. In the rinsing bath, the semiconductor wafer is rinsed by DI water. The rinsing bath can be formed in a variety of types. However, the rinsing bath has an opened end connected to a bath connecting tube of the bath tunnel unit 120.

The first guide support 116 supports and moves the wafer guide 140. For example, the first guide support 116 may include a first vertical support 116a and a first horizontal support 116b coupled to the first vertical support 116a. The first vertical support 116a is connected to the wafer transferring unit 160 so as to move the first guide support 116. The first horizontal support 116b supports the wafer guide 140, contacting the wafer guide 140.

The drying unit 130 includes a drying bath 132, a drying chamber 134 and a second guide support GS2 (136). The drying bath 132 is a space in which the semiconductor wafer W2 transferred from the rinse unit 110 stays before the drying process is performed. Alternatively, the drying bath 132 may be a space in which the transfer of the wafer guide 140 occurs from the first guide support 116 to the second guide support 136. The drying bath 132 is also filled with DI water. The drying bath is not limited in its structure. However it has an opened end connected to the other end of the bath connecting tube.

In the drying chamber 134, the drying process is performed by spraying isopropyl alcohol and high temperature nitrogen on the semiconductor wafer W3. The drying chamber is not limited in its structure, having an opened bottom connected to the drying bath 132. The drying chamber 134 may closely contact the drying bath 132. Alternatively, the drying chamber 134 may be connected to the drying bath 132 with both being isolated from the air.

The second guide support 136 supports and moves the wafer guide 140. For example, the second guide support 136 includes a second vertical support 136a and a second horizontal support 136b coupled to the second vertical support 136a. The second vertical support 136a is connected to one of the elements of the wafer transferring unit 160 to move the first guide support 136. The second horizontal support 136b contacts the wafer guide 140 to support the wafer guide 140.

The wafer transferring unit 160 moves the plural semiconductor wafers W loaded in the rinsing unit 110. The semiconductor wafers W are transferred in a state where they are loaded in the wafer guide 140. The wafer transferring unit 160 includes first and second moving units 155 and 150 for driving first and second vertical supports 116a and 136a, respectively.

For example, the first moving unit 155 is designed to move the first guide support 116 in a first direction parallel to the ground between the rinsing unit 110 and the drying bath 132 of the drying unit 130. At this point, the first guide support 116 moves from the rinsing unit 110 to the drying bath 132 via the bath tunnel unit 120. The second moving unit 150 is designed to move the second guide support 136 in a second direction vertical to the ground between the drying bath 132 of the drying unit 130 and the drying chamber 134.

At this point, the wafer guide 140 is moved from the first guide support 116 to the second guide support 136 in the drying bath 132. As shown in FIG. 2, by driving the second guide support 136 in a vertical direction intersecting the first guide support 116, the wafer guide 140 is transferred from the first guide support 116 to the second guide support 136.

Alternatively, the first moving unit 155 may be designed to move the first guide support 116 in the first direction between the rinsing unit 110 and the bath tunnel unit 120. In this case, the second moving unit 150 may be designed to move the second guide support 136 in the second direction between the drying bath 132 of the drying unit 130 and the drying chamber 134 and to move the second guide support 136 in the first direction between the drying bath 132 and the bath tunnel unit 120.

In the apparatus including the wafer transferring unit 160, the transfer of the wafer guide 140 from the first guide support 116 to the second guide support 136 is performed in the bath connecting tube 122 of the bath tunnel unit 120. In order to transfer the wafer guide 140 from the first guide support 116 to the second guide support 136 in the bath connecting tube 122, the second moving unit 150 may be designed to move the second guide support 136 in the second direction. If required, the first moving unit 155 is also designed to move the first guide support 116 in the second direction in the bath connecting tube.

The bath tunnel unit 120 includes a closing/opening unit 125 as well as the bath connecting tube 122. The bath connecting tube 122 connects the rinsing bath to the drying bath 132. Since the semiconductor wafer loaded in the wafer guide 140 is transferred via the bath connecting tube 122, the semiconductor wafer is not exposed to the air between the rinsing process and the drying process. Since the transferring path from the rinsing bath to the drying bath is short, the time for transferring the wafer guide 140 can be saved, thereby improving the throughput.

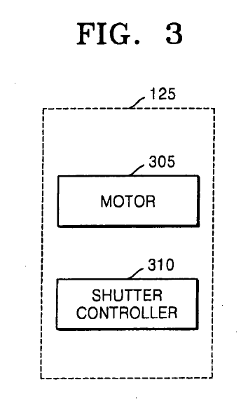

The closing/opening unit 125 functions to open the bath connecting tube 122. The closing/opening unit 125 includes a shutter, a motor 305 of FIG. 3 for driving the shutter to open/close the bath connecting tube 122 and a shutter controller 310 of FIG. 3 for controlling the motor operation.

The bath connecting tube 122 is closed during the rinsing process to prevent the compound dissolved in the DI water from being dispersed to the drying bath. After the rinsing process is completed and the impurity content in the DI water of the rinsing bath becomes identical to the impurity content in the DI water of the drying bath, the bath connecting tube 122 is preferably opened.

A method for rinsing and drying the semiconductor wafer using the rinsing/drying apparatus 110 will be described hereinafter.

FIG. 4 shows a flowchart illustrating a method of rinsing and drying a semiconductor wafer according to an embodiment of the present invention.

Referring to FIGS. 1 through 4, the plural semiconductor wafers W1 are loaded in the first guide support 116 in the rinsing bath of the rinsing unit 110 at step S10. The semiconductor wafers W1 may be loaded one by one by a robot or loaded in a state where they are loaded in the wafer guide 140. In the case of the former, the wafer guide 140 is provided on the first guide support 116.

Then, the rinsing process for the loaded semiconductor wafers W1 is performed at step S12. At this point, the bath connecting tube 122 is closed by the closing/opening unit 125. The rinsing process is performed identically to that of the prior art. For example, new DI water is supplied through the bottom of the rinsing bath filled with the DI water. As a result, a flow current of the DI water is generated in the rinsing bath and contacts the semiconductor wafers W1 to remove the compounds and impurities from the surfaces of the wafers W1. The removed compounds and impurities are exhausted to an exterior side together with the DI water overflowing the rinsing bath. The rinsing process may be performed for 200-300 seconds.

Next, the closing/opening unit 125 is driven to open the bath connecting tube 122 at step S14. For example, as shown in FIG. 1, the shutter S is driven to open the bath connecting tube 122. When the DI water contained in the rinsing bath is purified as clean as that contained in the drying bath 132, the bath connecting tube 122 is opened.

Then, the semiconductor wafers are transferred from the rinsing bath to the drying bath at step S16. As a result, the semiconductor wafers W2 are located in the drying bath 132. This operation can be realized in a variety of methods.

As an example of the methods, the wafer guide 140 may be transferred in the drying chamber 132. That is, the first moving unit 155 is driven to transfer the first guide support 116 supporting the wafer guide 140. The first guide support 116 is horizontally moved until it reaches the drying bath 132 via the bath connecting tube 122. The reference sign GS1-1 of FIG. 1 indicates a moving path of the first guide support 116 in this operation. The second guide support 136 is located in the drying bath 132. As a result of the transfer, the first horizontal support 116a of the first guide support 116 is disposed at a level higher than that of the second horizontal support 136b, intersecting the second horizontal support 136b of the second guide support 136.

Then, the second moving unit 150 is driven in a state where the first guide support 116 is fixed, thereby moving the second guide support 136 in the vertical direction. The reference sign GS2-11 of FIG. 1 indicates a moving path of the second guide support 136 in this operation. At this point, the wafer guide 140 is transferred from the first horizontal support 116b to the second horizontal support 136b as the second horizontal support 136b intersects the first horizontal support 116b.

As another example of the methods, the wafer guide 140 may be transferred in the bath connecting tube 122. That is, the first moving unit 155 is driven to transfer the first guide support 116 supporting the wafer guide 140. The first guide support 116 is horizontally moved until it reaches the bath connecting tube 122. The reference sign GS1-2 of FIG. 1 indicates a moving path of the first guide support 116 in this operation.

The second guide support 136 is transferred to the bath connecting tube 122 the moment or before the first guide support 116 is moved. The reference sign GS2-21 of FIG. 1 indicates a moving path of the second guide support of this operation. As a result of the movement, the first horizontal support 116a of the first guide support 116 is disposed at a level higher than that of the second horizontal support 136b, intersecting the second horizontal support 136b of the second guide support 136. The intersecting point of this example becomes the bath connecting tube 122 while the intersection point of the previous example is the drying bath 132.

Then, the second moving unit 150 is driven in a state where the first guide support 116 is fixed, thereby moving the second guide support 136 in the vertical direction. The reference sign GS2-22 of FIG. 1 indicates a moving path of the second guide support 136 in this operation. At this point, the wafer guide 140 is transferred from the first horizontal support 116b to the second horizontal support 136b as the second horizontal support 136b intersects the first horizontal support 116b. Then, the second moving unit 150 is driven to move the second guide support 136 in the horizontal direction until the second guide support 136 is located in the drying bath 132. The reference sign GS2-23 indicates a moving path of the second guide support 136 in this operation.

Next, the shutter S is returned to its initial state to close the bath connecting tube 122 at step S18. This operation may not be performed immediately after the guide support 140 is transferred. That is, this operation may be performed before the following semiconductor wafer is loaded in the rinsing unit 110. However, before the bath connecting tube 122 is closed, the first guide support 116 must be returned to the rinsing bath by driving the first moving unit 155. The reference signs GS1-1 and GS1-2 indicate a moving path of the first guide support 116 in this operation.

After the above, the semiconductor wafers W3 are transferred to the drying chamber at step S20. That is, the second moving means is driven to move the second guide support 136 supporting the wafer guide 140 from the drying bath 132 to the drying chamber 134. The reference signs GS2-12 and GS2-24 indicate a moving path of the second guide support 136 in this operation.

Next, the drying process for the semiconductor wafers W3 is performed in the drying chamber 134 at step S22. The drying process is performed in a manner similar to that of the rinsing process. For example, the isopropyl alcohol and high temperature nitrogen are sprayed into the drying chamber 134 in which the semiconductor wafers W3 are loaded. Since the isopropyl alcohol is volatile, it functions to vaporize the water adhered to the semiconductor wafers W3. The nitrogen functions as a carrier for the isopropyl alcohol.

Then, the dried semiconductor wafers are unloaded to an exterior side of the drying chamber 134 at step S24, after which, or at the same time, the first and second guide supports are returned to their initial states. The bath connecting tube 122 may be closed during or after the semiconductor wafers are unloaded.

After the drying process for the current wafers is finished, the rinsing and drying processes for other wafers can be performed in the identical method. Alternatively, in the course of drying the current wafers, other wafers are loaded in the rinsing unit 110 to undergo the rinsing process.

According to the rinsing and drying apparatus for the semiconductor wafers, since the semiconductor wafers are transferred through the bath connecting tube, the exposure of the semiconductor wafer to the air between the rinsing and drying processes can be prevented. As a result, no watermarks are formed on the semiconductor wafers. Furthermore, since the transferring path of the semiconductor wafers is short, the time for performing the rinsing and drying processes can be shortened, thereby improving the throughput.

In addition, since the rinsing and drying processes are performed in respective separated baths, the drying process for current wafers and the rinsing process for subsequent wafers can be simultaneously performed, thereby improving the throughput.

Furthermore, since the rinsing and drying processes are independently performed from each other, the apparatus of the present invention can be employed to a variety of applications.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of rinsing and drying semiconductor wafers, comprising:
loading the semiconductor wafers into a rinsing bath;
rinsing the semiconductor wafers in the rinsing bath;
opening a bath connecting tube connected to the rinsing bath by driving an opening/closing unit;
transferring the semiconductor wafers to a drying bath through the bath connecting tube, the bath connecting tube preventing the semiconductor wafers from being exposed to air when the semiconductor wafers are transferred from the rinsing bath to a drying bath;
transferring the semiconductor wafers to a drying chamber;
drying the semiconductor wafers; and
unloading the semiconductor wafers from the drying chamber.

2. The method of claim 1, further comprising closing the bath connecting tube by driving the opening/closing unit after transferring the semiconductor wafers to the drying bath.

3. The method of claim 1, wherein transferring the semiconductor wafers to the drying bath includes transferring a wafer guide carrying the semiconductor wafers to the drying bath.

4. The method of claim 3, wherein transferring the semiconductor wafers to a drying chamber includes transferring the wafer guide carrying the semiconductor wafers to the drying chamber.

5. The method of claim 3, wherein transferring the wafer guide carrying the wafers to the drying bath includes transferring the wafer guide on a first guide support.

6. The method of claim 5, wherein transferring the semiconductor wafers to a drying chamber includes transferring the wafer guide carrying the semiconductor wafers to the drying chamber; and
transferring the wafer guide carrying the semiconductor wafers to the drying chamber includes transferring the wafer guide on a second guide support.

7. The method of claim 1, wherein the step of transferring the semiconductor wafers to a drying chamber comprises:
moving the semiconductor wafers on a first guide support into the drying bath along a first horizontal path; and
moving a second guide support into the drying bath in a first part along a second horizontal path lower than the first horizontal path of the first guide support and then vertically in a second part to intersect the first horizontal path and effect a transfer of wafers from the first guide support to the second guide support.

8. The method of rinsing and drying semiconductor wafers of claim 7, further including the step of returning the first guide support from the bath tunnel unit to the rinsing unit once the transfer of wafers has taken place to receive a second load of wafers.

9. The method of rinsing and drying semiconductor wafers of claim 7, further including the step of returning the second guide support along a third part from the bath tunnel unit to the drying chamber along a horizontal path.

10. A method of rinsing and drying semiconductor wafers, comprising:
loading semiconductor wafers onto a first guide support;
moving the first guide support with the semiconductor wafers into a rinsing unit and rinsing the semiconductor wafers in the rinsing bath;
opening a bath tunnel unit connected to the rinsing unit by driving an opening/closing unit;
moving the first guide support along a first horizontal moving path between the rinsing unit and the bath tunnel unit; and
moving a second guide support along a second moving path between the drying chamber and the bath tunnel unit, the second moving path including a first part moving horizontally toward the bath tunnel unit and disposed at a lower level than the first moving path, and a second part moving vertically to intersect the first horizontal moving path and effect a transfer of wafers from the first guide support to the second guide support.

11. The method of rinsing and drying semiconductor wafers of claim 10, further including the step of returning the first guide support from the bath tunnel unit to the rinsing unit once the transfer of wafers has taken place to receive a second load of wafers.

12. The method of rinsing and drying semiconductor wafers of claim 10, further including the step of returning the second guide support along a third part of the second moving path from the bath tunnel unit to the drying chamber along a horizontal path.
